(19) United States
(12) Patent Application Publication
(10) Pub. No.: US 2009/0193466 A1
(43) Pub. Date: Jul. 30, 2009

(54) DISTRIBUTED NETWORK-BASED VIDEO CONTENT FOR TELEVISION

(76) Inventors: David Ehreth, Healdsburg, CA (US); Philip A. Wilkinson, Healdsburg, CA (US)

Correspondence Address: FISH & RICHARDSON P.C., P.O. BOX 1022, MINNEAPOLIS, MN, 55440-1022, US

(21) Appl. No.: 12/019,252

(22) Filed: Jan. 24, 2008

(51) Int. Cl. G06F 13/10; H04N 7/173

(52) U.S. Cl. 725/47; 725/110

(57) ABSTRACT

This disclosure generally relates to providing network-based video content to television viewers. For example, software for providing network-based video over a television can provide a graphical user interface (GUI) to the television for presentation to a viewer. Then, in response to input through the GUI, the software can identify a plurality of remote video content providers and provide a video from one of the remote video content providers over a computer network to the television. This software may be communicably coupled with a central repository that stores information associated with a plurality of remote video content providers. Software associated with the repository may query the repository in response to a request from the remote client. This “repository” software can provide information associated with a subset of the plurality of remote video content providers, selected based on the query, to the remote client.

### TECHNICAL FIELD

This disclosure generally relates to providing television content and, more particularly, to providing distributed, or network-based, video content to television viewers.

### BACKGROUND

To date, cable, telephone and satellite operators have recreated, and significantly enhanced, a version of the older style of broadcast television. Community Access (or Antenna) Television (CATV or “cable”) was the first to bring television to communities underserved by radio frequency (RF) broadcasting of television signals. Although CATV was based on analog technology and used a broad spectrum of analog channels (broadband), the economic efficacy of network television distribution was well demonstrated. Eventually, cable operators converted their systems to hybrid-fiber-coax (HFC) technology that combined digital and analog distribution technologies to greatly expand their service offerings. Also, satellites with digital broadband broadcast capabilities were placed in orbit and primarily aimed at the lucrative markets of North America and Europe.

In spite of the myriad channels offered by the operators, there are two important deficiencies: i) limited programming and ii) a schedule determined by the broadcasters. The glue that binds this strategy together is television subscription, which offers limited programming via select channels. In this way, these operators generally control viewer access to content. In this manner, the network operator is able to take a slice of the television programming pie by charging the viewer for access, whatever the limitations on that service are in terms of content. The “set-top box” (STB) is the key to control of television programming revenue. In effect, it is the STB that gives access, and restricts access, to programming for subscribers. The set-top box performs the following basic functions: basic usage authorization; level of authorization (premium channel access); point of sale for video on demand (VOD) or near video on demand (NVOD); viewing options including menus, channel and time information, and, in the case of telephone and satellite STBs, graphical user interfaces (GUIs); decoding of digital signals; viewer remote controller; parental controls; and complete control of viewer's access to content. By exercising this control, network operators gain control over both users and content providers.

With the digital era of television distribution has also come the ability to micro-target advertising while having multiple ads running in the same time slot in different locations. In the past, a broadcast television station was given a metro-regional charter. Advertising done on one of these stations would be seen throughout the reception area of that station. As television signal distribution became more digital and more cable or wire oriented, it became possible to sectionalize the audience to a much greater extent. The impact on advertisers and broadcasters alike has been positive. The number of advertisers for a given 30 seconds of television broadcasting has grown, while the ads themselves can be better targeted resulting in improved impact.

Digital Video Recorders (DVRs), such as TiVo, combined three technologies that revolutionized how many viewers watch TV The first element is the database of all programming available through a given network operator. The second piece is the DVR box capable of recording hours of digital TV programming. Finally, program information is presented to the user through a user-friendly multifunctional graphical user interface (GUI). One significant impact of DVRs is that viewers now make their own viewing schedules. This “time shifting” means that two TV shows no longer compete against each other in “prime time” time slots. In fact, with DVRs, the concept of “prime time” has been diminished, if not altogether lost. For TV content providers (or television networks), time shifting has even greater meaning. Specifically, they now have an opportunity to sell more programming than there is real time in which to broadcast. Simply put, the 24-hour per day time limit for programming has been eliminated. With the advent of DVRs, TV advertisers have lost a significant audience and it remains to be seen how advertisers will respond.

### SUMMARY

This disclosure generally relates to providing network-based video content to television viewers. For example, software for providing network-based video over a television can provide a graphical user interface (GUI) to the television for presentation to a viewer. Then, in response to input through the GUI, the software can identify a plurality of remote video content providers and provide a video from one of the remote video content providers over a computer network to the television. This software may be communicably coupled with a central repository that stores information associated with a plurality of remote video content providers. Software associated with a repository may query the repository in response to request from the remote client. This “repository” software can provide information associated with a subset of the plurality of remote video content providers, selected based on the query, to the remote client.

While generally described as software, some or all of these techniques and aspects may be further included in respective systems or other devices. The details of these and other aspects and embodiments of the disclosure are set forth in the accompanying drawings and the description below. Other features, objects, and advantages of the present disclosure will be apparent from the description and drawings, and from the claims.

### DESCRIPTION OF DRAWINGS

FIG. 1 is a block diagram illustrating an example network-based video service system in accordance with certain embodiments of the present disclosure;

FIG. 2 illustrates an example view interface (or GUI) for using the system of FIG. 1;

FIG. 3 illustrates an example layout of the content profile used in the system of FIG. 1;

FIG. 4 is a flowchart depicting an example technique for processing viewer input to locate distributed video content in accordance with certain embodiments of the present disclosure;

FIG. 5 is a flowchart depicting an example technique for processing viewer input to locate targeted advertisements in accordance with certain embodiments of the present disclosure; and

FIG. 6 is a flowchart depicting an example technique for processing viewer input at the local client to present the selected video on the television in accordance with certain embodiments of the present disclosure.

### DETAILED DESCRIPTION

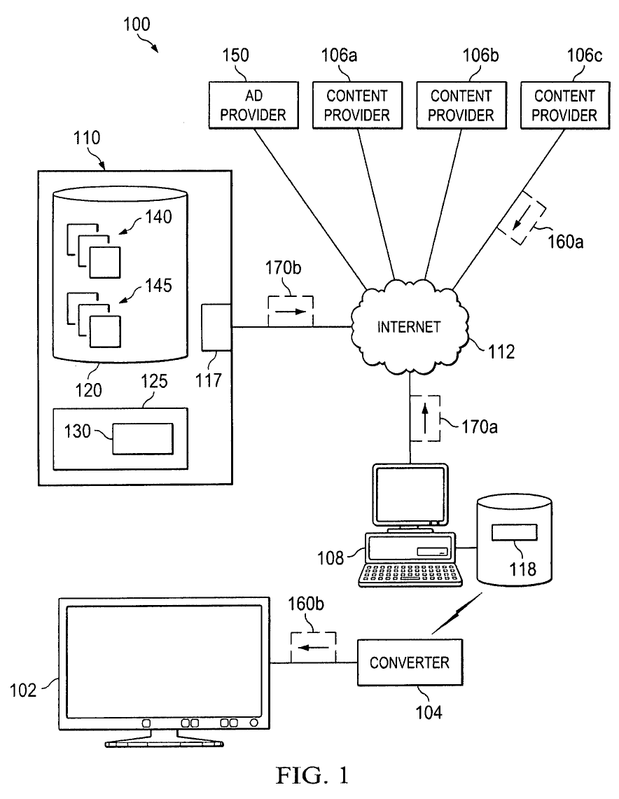

FIG. 1 is a block diagram illustrating an example system 100 involving identifying, providing, or otherwise managing network-based video content viewable on televisions. For example, the system 100 can access third party programming content through the Internet (or any other computer network) by converting it to a form compatible with a television screen and may, in addition, provide control capabilities to the television viewer. As such, system 100 moves content from the personal computer (PC) to the television screen along with powerful control capabilities. Examples of such video content on the Internet are the myriad news shorts from all of the major news services, as well as YouTube, which is probably the single largest source of video content on the Internet. Other examples include serial television programs; movies; education and training; local sports events; advanced blogging sites (independent news sources); travel-related information; food and cooking; topical movies and videos (e.g., surfing, sailing, racing, extreme sports, etc.); political uses including political campaigning, adult content, court and trial programming; local government uses (e.g., C-SPAN), local programming, performing arts (theater, concerts, music video, etc.); and “virtual shopping malls” (sites for commercial activity). Unlike prescheduled programming, system 100 gives viewers on-demand access that additionally frees content developers from “prime-time” competition and opens up vast new programming possibilities. Indeed, system 100 has the potential to provide advertisers with an entirely new venue where advertising can be associated with programming content in a manner less likely to be bypassed by viewers. Additionally, advertisers can have (paid) access to the user menu system, a menu system with greater depth than typical programming menus.

More specifically, the system 100 uses software or a set-top box (relatively local to television 102) to modify, translate, or otherwise convert foreign video to an analog signal compatible with the television 102. For example, the system 100 may convert video communications between Internet Protocol (IP) packets and an analog signal compatible with or otherwise native to the television 102. Foreign, as used herein, means any media, software object, value, variable, data, protocol, and/or data schema that is not directly processable, accessible, or otherwise capable of communicating with the television 102. In most cases, the conversion of the foreign services to compatible forms is transparent to the user of the television 102. Foreign services may include video conferencing, call sessions (e.g., VoIP), data sessions (e.g., Movies on Demand), and/or other services that are at least partially incompatible with the television 102. Indeed, the system 100 may provide these services to the television 102 independent of network providers, service providers, and/or content providers.

Turning to a more detailed description of the illustrated system, system 100 includes a viewer's location (with television 102 and client 108, running client software 118), multiple content providers 106, and a central content repository at server 110 that span one or more networks, such as 112, to utilize and communicate electronic data. Generally speaking, the central content server 110 provides the viewer at television 102 with centralized and efficient access to the many network videos provided, served, or facilitated by a plurality of contents providers (such as illustrated 106a-c).

The television 102 generally includes an internal tuner and can further include any software, hardware, and/or firmware for displaying video to a viewer. In some implementations, the tuner in the television 102 may be a Phase Alternating Line (PAL) tuner, a National Television System Committee (NTSC) tuner, an Advanced Television Systems Committee (ATSC) tuner (or “HD” tuner), and so forth. For example, the television 102 may be an analog television set configured to receive analog signals through one or more inputs. Such inputs may include composite-video inputs, cable inputs, antennas, S-video inputs, RF-connector inputs, and others. The television 102 can also include, alternatively or in combination, digital inputs such as High-Definition Multimedia Interface (HDMI), Digital Visual Interface (DVI), or others. In the case of digital signals, the television 102 may include a converter (not illustrated) for converting digital signals to analog signals and/or may process digital signals in one or more formats. To display images, the television 102 may include any of the following technologies: cathode-ray tube, rear projection, liquid crystals, plasma, Digital Light Processing (DLP), and others. In some cases, television 102 is located so that multiple viewers can view the presented materials, such as in a living room, TV room, bedroom, conference room, and so forth. As such, it should be noted that while generally described in terms of a “viewer,” any number of people may control or watch what is presented on their television 102, perhaps via a remote control (not illustrated).

The television 102 is communicably coupled with a convertor 104, which is further communicably coupled with client 108. Accordingly, the convertor 104 includes any software, hardware, and/or firmware configured to provide or facilitate communication between the television 102 and the client 108. The convertor 104 is often a set-top box that is independent of the particular television 102, its model, or manufacturer. Put another way, the same convertor may be coupled to a plurality of televisions 102 of various types, models, and brands. In some implementations, the convertor merely enables television 102 to conduct network communications with client software 118. In other implementations, the convertor 104 is substantially managed by the client 108 using Ethernet and/or other data transport protocols. The convertor 104 may convert the received signal to a digital and/or analog signal compatible with the television 102 in any suitable format. In the case of analog signal, the convertor 104 may include digital-to-analog converters (DACs) and/or analog-to-digital converters (ADCs). For example, the communication convertor 104 using DACs and ADCs may present digitally encoded signals on the television 102. The convertor 104 may wirelessly communicate signals to the client 108 using any appropriate spectrum. For example, the convertor 104 may convert between a WiFi signal compatible with the client 108 and a wireline signal compatible with the television 102. This conversion may be hardwired into the convertor or (alternatively or in combination) using service profiles to map, process, and convert the various formats, protocols, etc.

These example service profiles comprise instructions, mappings, algorithms, or any other directive for translating, mapping, or otherwise converting video from the content providers 106 for use by television 102. In general, the service profile may include a formalized way of representing technical, logical, and other properties of foreign services in the different content providers 106. For example, the service profiles may identify a network address and login information for accessing multimedia from a particular logical location and it may identify a network address and login information for accessing media in a third-party database. Technical information may include one or more of the following: a network address, login information, authentication information, instructions for accessing the services, service formats, service protocols, a server name, a database name, a data source name, a database table name, a column name, service commands, and/or other information associated with accessing foreign services. As a result, the service profile 406 may eliminate, minimize or otherwise reduce the need for additional hardware, software, and/or firmware in the television 102 to enable access to the foreign services. For example, the service profile may include instructions for receiving digitally encoded foreign services and convert the services to an analog signal compatible with an analog television 102. In addition, the service profile is typically created, deployed, and maintained independently of the television 102, its model, or its manufacturer. Accordingly, the foreign services available to the television 102 may be expanded and/or enhanced by adding or enhancing service profiles, typically without modifying or altering the television 102. In some implementations, the service profiles are based, at least in part, on information received by the server 110 for use by client 108 in preparing the information for television 102 or convertor 104.

The client 108 comprises any electronic device operable to receive, transmit, process and store any appropriate data (e.g., images, video) associated with system 100, namely a device that includes, executes, or otherwise presents the GUI 116 to the viewer via television 102. In some implementations, the client 108 includes software 118 configured to enable the television 102 to access foreign services provided by one or more content providers 106 and/or network 110. In general, the client 108 may include software that provides one or more of the following: manage data streams, negotiate services with content providers 106, designate local storage space when required by foreign services, maintain relevant databases for data associated with foreign services, execute different interfaces for different operating systems, provide different provisioning hooks for different services, and so forth. For example, the client 108 may receive the distributed video, directly incompatible with the television 102, and convert it to a form compatible with the television 102. This software 118 may comprise an agent of video content manger 130, a stand-alone software application, a module, library, or other software process or configuration. Regardless of the particular implementation, “software” or “computer readable instruction” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others. It will be understood that while the software illustrated herein is shown as a single module that implements the various features and functionality through various objects, methods, or other processes, the software may instead include a number of sub-modules, third party services, components, libraries, and such as appropriate. Conversely, the features and functionality of various components can be combined into single components as appropriate.

With respect to receiving the video, the client software 118 may use authentication information associated with the user to access the foreign services. For example, the client 108 may identify locally stored login, password, and instructions for accessing the particular service and transmit a request based, at least in part, on the locally stored data. Alternatively, or in addition, the authentication information may be associated with subscriber services. For example, the authentication information may be used to access some video services provided by the content provider 106, but not other video services from the content provider 106. In some implementations, the client 108 can modify, translate, or otherwise convert between different formats in connection with providing foreign services to the television 102. For example, the client 108 may receive network packets encoding a movie and convert the signal into Ethernet frames for transmission to the communication convertor 104. In another example, the client 108 may also receive Ethernet frames from the convertor 104 and convert or otherwise generate IP packets for transmission through the network 112 based, at least in part, on the Ethernet frames. In some implementations, conversion of the video is transparent to the television 102, the content providers 106, and/or network 112. The translation and authentication services offered by the client 108 may also be transparent to the television 102, content providers 106, and/or network 112.

To accomplish some or all of the foregoing, client 108 typically includes (or is coupled with) memory or database modules that may take the form of volatile or non-volatile memory including, without limitation, magnetic media, optical media, RAM, ROM, removable media, or any other suitable local or remote memory component. In some implementations, the client 108 is configured to function as a virtual DVR and may buffer content received from the content providers. In some implementations, the client does not require a significant disk capability (e.g., 30 GB to 300 GB) because the video content is persisted elsewhere until selected by the user. If desired, this video content is then purged from the system after viewing. Client 108 is intended to encompass a personal computer, touch screen terminal, workstation, network computer, kiosk, wireless data port, smart phone, personal data assistant (PDA), one or more processors within these or other devices, or any other suitable processing or electronic device used by an advertiser to access the network 112. For example, client 108 may be a PDA operable to wirelessly connect with an external or unsecured network. In another example, client 108 may comprise a laptop that includes an input device, such as a keypad, touch screen, mouse, or other device that can accept information, and an output device that conveys information associated with the system 100, including digital data, visual information, and GUIs. Both the input device and output device may include fixed or removable storage media such as a magnetic computer disk, CD-ROM, or other suitable media to both receive input from and provide output to users of clients 108 through the television 102, namely the client portion of GUI 116.

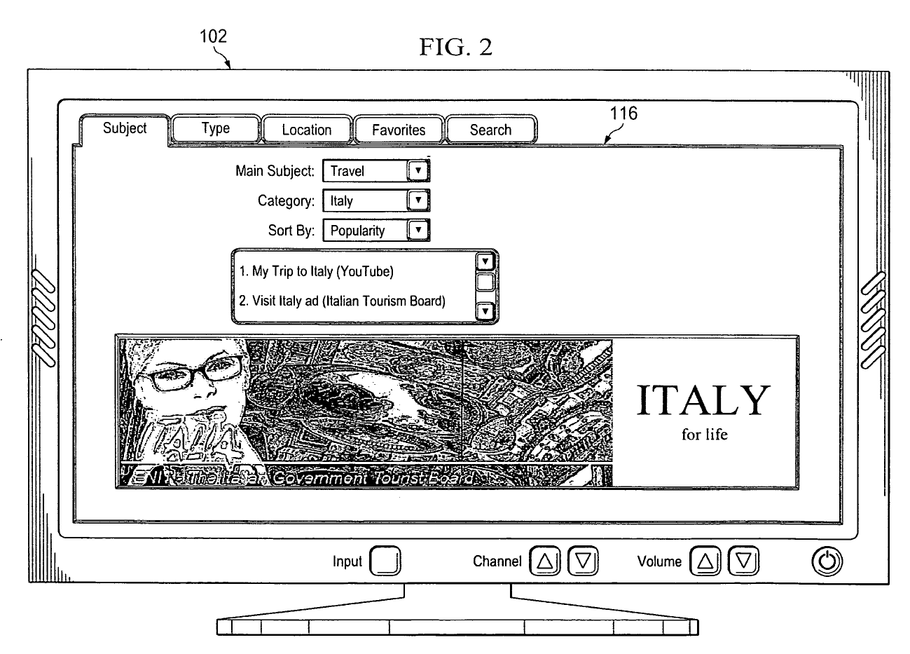

GUI 116 comprises a graphical user interface operable to allow the television viewer to interface with at least a portion of environment 100 for any suitable purpose, such as viewing application, modeling, or hierarchical data. Generally, GUI 116 provides the viewer with an efficient and user-friendly presentation of data provided by or communicated within environment 100. More specifically, GUI 116 can be the front-end of the video client software or include various interfaces representing such video distribution. In some cases, GUI 116 may comprise a web browser that includes a plurality of hierarchical views having interactive fields, pull-down lists, and buttons operated by the user. For example, GUI 116 is operable to display certain presentation elements, such as videos and links, in a user-friendly form based on what the user, or viewer, is trying to accomplish. As illustrated in FIG. 2, GUI 116 can present the viewer with an initial menu that quickly guides him to content that he is interested in viewing. As illustrated, this menu will allow the viewer to find content by type, subject, location, through a “favorites” menu, or via an alphabetical search. Through this menu experience, the user will be offered a “search or browse” option that allows him to go either directly to known content or to browse a range of options. In this example illustration, the user selects the “Subject” category, and from that menu selects “Travel” and then “Italy,” and is then presented with a variety of travel information, documentaries, travel guides from which they can select. Should the user have chosen “Entertainment” from the “Type” menu, he might have chosen to go to a content provider 106 offering a serialized story typical of current television programming. Because the content provider 106 has entered content information into central repository at server 110, the viewer can see what's available in a format that is consistent from content provider 106 to content provider 106. Once selected, server 110 supplies the client 108 with the URL (or other logical location) for the video content in a transaction typically not visible to the viewer. Once the client 108 is in possession of the content URL, the client 108 accesses the site identified by the content provider, conducts whatever appropriate transaction is necessary, and then launches the video stream for presentation at television 102. In most cases, a small amount of buffering at the client 108 can help overcome any network latency issues. The user then views his requested content upon completion of the transaction (perhaps several seconds). The client software can then allow the viewer to pause, rewind, fast forward, freeze, or move in slow motion within a particular window of the program that is being viewed (such as 30 minutes).

By providing menu-associated embedded advertising, highly targeted advertising can be presented to viewers who are searching the database in areas that would suggest their interest in certain topical areas. For example, a viewer searching the sports section of the repository may be interested in an advertisement for a sports magazine, and as that viewer descends a layer in the database to fishing, advertising for products relating to fishing are presented. Then, finally, when the view arrives as content related to deep sea fishing in Baja, advertising for a variety of products relating to that person's interests can be presented. These ads may be located at server 110 or may be referenced in ad profiles 145, which can reference ad provider (or ad server) 150. Additionally, as content providers become more directly linked to viewers, they will be able to strike their own advertising deals based on viewing statistics provided by server 110. Advertisements can then be linked directly to content (at the risk of being “fast-forwarded”) or by “placements”—products that are embedded in the video content itself.

It should be understood that the term “graphical user interface” may be used in the singular or in the plural to describe one or more graphical user interfaces and each of the displays of a particular graphical user interface. Indeed, reference to GUI 116 generally indicates a reference to the front-end or a component of the client software 118, as well as the particular interface accessible via television 102, as appropriate, without departing from the scope of this disclosure. Therefore, GUI 116 contemplates any graphical user interface, such as a generic web browser or touchscreen, that processes information in environment 100 and efficiently presents the results to the user. Server 110 can accept data from client 108 via the web browser (e.g., Microsoft Internet Explorer or Mozilla Firefox) and return the appropriate HTML or XML responses to the browser using network 112.

The network 112 facilitates wireless and/or wireline communication between the server 110 and any other local or remote computer, such as the clients 108. Generally, network 112 can be considered the internet and other local networks so that the various devices can communicate with the particular recipient. Indeed, while illustrated as one continuous network, network 112 and the various components may be further distributed across multiple networks without departing from the scope of this disclosure, so long as at least a portion of network 112 may facilitate communications between senders and recipients of requests and results. For example, the viewer's television and client 108 may be connected across a wireline or wireless link. Such an example wireless link may be via 802.11a, 802.11b, 802.11g, 802.20, WiMax, and many others. In another example, a portion of network 112 may be a virtual private network (VPN) merely between the server 110 and the client 108. In yet another example, a portion of illustrated network 112 may represent part of an intranet, while another portion network 112 may represent part of the internet. In other words, network 112 encompasses any internal or external network, networks, sub-network, or combination thereof (whether physical or logical) operable to facilitate communications between various computing components in the system. The network 112 may communicate, for example, Internet Protocol (IP) packets, Frame Relay frames, Asynchronous Transfer Mode (ATM) cells, voice, video, data, and other suitable information between network addresses. The network 112 may include one or more local area networks (LANs), radio access networks (RANs), metropolitan area networks (MANs), wide area networks (WANs), all or a portion of the global computer network known as the Internet, and/or any other communication system or systems at one or more locations, such as server 110 and content providers 106.

Server 110 comprises an electronic device (e.g., computing device) operable to receive, transmit, process and store data associated with system 100. The server 110 can be implemented using computers other than servers, as well as a server pool. Indeed, the server 110 may be any computer, electronic or processing device such as, for example, a blade server, general-purpose personal computer (PC), Macintosh, workstation, Unix-based computer, or any other suitable device. In other words, the server 110 may include computers other than general purpose computers, as well as computers without conventional operating systems. The server 110 may be adapted to execute any operating system including Linux, UNIX, Windows Server, or any other suitable operating system. In some implementations, the server 110 may also include or be communicably coupled with a web server and/or a mail server.

The server 110 includes memory 120 and a processor 125. The memory 120 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, the memory 120 includes content profiles 140 and ad files 145. Local memory 120 may also include any other appropriate data such as VPN applications or services, firewall policies, a security or access log, print or other reporting files, HTML files or templates, data classes or object interfaces, child software applications or sub-systems, and others.

At a high level, content profiles 140, or information associated therewith, represent a central repository of video content data for use by television viewers. For example, where normal broadband television systems (cable and satellite) are limited by the number of discrete video channels that can be packed into their usable spectrum, no such constraints exist using this repository, typically because the content database stores information about content, but not the content itself. Using this technique, content and content providers can grow without limits. Through their session, viewers will be able to conduct simple, but sophisticated multilevel searches that will be highly superior to current subscription TV offerings. For content providers, the database will ensure that they have instant access to an audience and the ability to advertise their offerings if they so choose.

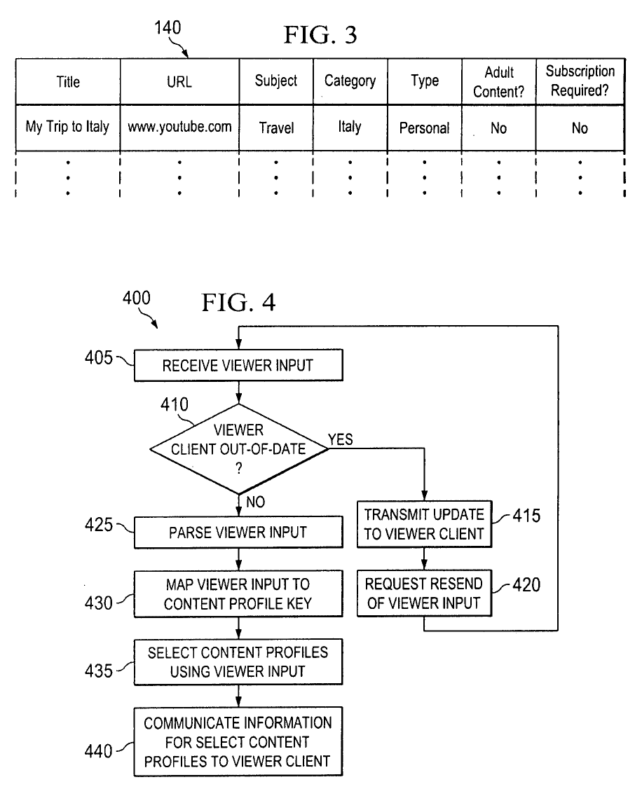

The content profiles 140 include any parameters, variables, policies, instructions, settings, rules or directives for identifying content residing in the example content providers 106a-c. For example, the content profile 140 may identify a URL, network address, or other logical location for the content provider 106 associated with requested content. For example, the content profile 140 may include one or more of the following: network address, content type, content title, series title, episode number, availability dates, ad spaces, content descriptions, login information, passwords, content format, subject, location, category, content length, age, and/or other information associated with presenting content using the television 102. But, as shown in FIG. 3, any appropriate information may be stored and used. The content being identified may come from a virtually unlimited number of sources as opposed to the traditional cable/satellite/broadband operator approach of strictly controlling that which can be viewed at any given moment. In some implementations, one or more of the profiles 140 can be associated specific content, series, content provider 106, and/or other aspect of content. In some implementations, multiple content profiles 140 can be associated with specific content based on different contexts. Profiles 140 may be stored in one or more tables stored in a relational database described in terms of SQL statements or scripts. In other implementations, the profiles 140 may be formatted, stored, or defined as various data structures in text files, Hyperlink Text Markup Language (HTML) files, eXtensible Markup Language (XML) documents, Virtual Storage Access Method (VSAM) files, flat files, Btrieve files, comma-separated-value (CSV) files, internal variables, or one or more libraries. In short, the profiles 140 may comprise one table or file or a plurality of tables or files stored on one computer or across a plurality of computers in any appropriate format. Moreover, the profiles 140 may be local or remote without departing from the scope of this disclosure and store any type of appropriate data.

Ad files 145 include any parameters, pointers, variables, algorithms, instructions, rules, files, links, or other data for including or otherwise identifying ads that may be embedded in content presented on the television 102. In general, the ad file 145 may be in any appropriate format and can include one or more of the following: network address, memory location, size, date, content, content type, section in content (e.g., period of time), type of advertisement (e.g., For-Profit, Non-Profit, Government), duration, time, in-stream location, and/or other aspects associated with an advertisement and/or content. For example, ad file 145 may identify an episode, a segment of the episode, size, days, and/or other parameters associated with embedding an ad in requested content. In some implementations, the ad file 145 may include an ad (e.g., video) for embedding in content. In this implementation, the server 110 can transmit the ad directly to the client 108. In some implementations, the ad file 145 may identify an ad space for content. For instance, the ad file 145 may identify a value associated with the ad space and an expression may determine a charge to an advertiser using one or more parameters (e.g., time, duration, number of impressions). Each ad file 145 may be associated with a specific content provider 106, specific content, a specific advertiser 150, and/or a plurality of ad files 145 may be associated with a content provider 106, specific content, or other aspects of the system 100. For example, a particular ad file 145 may merely be a pointer to a third-party ad stored remotely. In short, the ad file 145 may comprise one table or file or a plurality of tables or files stored on one computer or across a plurality of computers in any appropriate format. Put another way, reference to an ad file 145 may include reference to a particular record, tag, or field within ad file 145 as appropriate. Indeed, some or all of the ad files 145 may be local or remote without departing from the scope of this disclosure and store any type of appropriate data.

Processor 125 executes instructions and manipulates data to perform operations of the server 110. Although FIG. 2 illustrates a single processor 125 in server 110, multiple processors 125 may be used according to particular needs, and reference to processor 125 is meant to include multiple processors 125 where applicable. In the illustrated implementation, the processor 125 executes a content engine 130 at any appropriate time such as, for example, in response to a request or input from a user of server 110 or any appropriate computer system coupled with the network 110. The video content manager 130 can be in the form of software, for example, operable to manage requests for content from the client 108. For example, the video content manager 130 may identify content provided by the content provider 106 in accordance with a content request. In some implementations, the video content manager 130 may perform one or more of the following: receive a request for content from the client 108, identify one or more content profiles 140 based, at least in part, on the request, identify specific content and/or location information using the identified content profiles 140, transmit the location information (e.g., network address) to the client 108, and/or other functions associated with presenting content using the television 102. In some implementations, the video content manager 130 dynamically identifies content based on one or more parameters. In this case, the video content manager 130 may identify one or more parameters associated with the user, the request, and/or other information associated with the system 100. For example, the video content manager 130 may dynamically identify content based on previous user actions, such as previous selections of the user. The video content manager 130 can also include, reference, or invoke software configured to identify ads for embedding in content. For example, the video content manager 130 may identify an ad file 145 including an ad and transmit the ad to the client 108 for embedding in content. In these implementations, the video content manager 130 could execute one or more of the following: identify information associated with a request for content; identify one or more ad files 145 based, at least in part, on the requested information; determine a location of one or more ads for embedding in content; transmit ads and/or ad information to the client 108; transmit requests for ads to advertisers 150 to embed in the content or GUI 116; and/or other functions associated with embedding ads in media presented through the television 102.

Server 110 may also include interface 117 for communicating with other computer systems, such as clients 108, over network 112 in a client-server or other distributed environment. In certain embodiments, server 110 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals. Interface 117 may allow communications across network 112 via a virtual private network (VPN), SSH (Secure Shell) tunnel, or other secure network connection. Using network 112, the client 108 transmits a request 170a for content to the server 110. In response to the request, the video content manager 130 identifies one or more associated content profiles 140 and transmits information for accessing the content to the client 108. Using the access information, the client 108 retrieves or otherwise accesses the requested content, such as a video for presentation on television 102, from one or more content providers 106.

Content providers 106a-c comprise various entities that serve network-based video content. Specifically, each content provider may employ, operate, own, control, lease, or otherwise be associated with an electronic device (e.g., computing device) that receives, transmits, processes, or stores such video content for use by distributed users, such as the viewer. For example, content provider 106 may be a television studio, movie studio, or an entity that operates on behalf of the studio such as a distributor, a data warehouse, an online video site (such as YouTube), or any other suitable domain or web server. In another example, content provider 106 may be the general online video site. In a further example, content provider 106 may be an end user that publishes his videos via server 110. In yet another example, content provider 106 could be a news agency. Regardless of the particular entity, the content provider 106 may comprise a web server, a data warehouse, or any other computer device for storing or serving video over network 112. It will be understood that the content provider 106 may be blind or indifferent to the particular user form. In other words, the fact that the requesting user is a viewer watching the video on the television 102 may be transparent to the content provider 106. In some implementations, the content providers 106 can identify ad-space information associated with content. For example, ad-space information may identify or include one or more of the following: content, ad sizes, media types, time, date, different sections included in the content, viewer numbers, and/or any other parameters associated with an advertisement and/or content. The provided video content may be in any suitable format such as MPEG, streaming, podcast, and so forth. In connection with providing the video content, the server 110 or one of the content providers 106 may serve, request, or otherwise direct ads to the client 108 to embed in the requested content.

The ads include any media, pointers, instructions, files, links, or other data for easily providing secondary content, often for marketing purposes. For example, the ad may comprise an audio ad, a video ad, or other type of ad. Such ads may include (among other things) primary content, secondary content, and/or sponsored content. For example, the ad may include a text element, a graphics element, a multimedia element, an audio segment, or any other audio, graphical and/or display element. In a more specific example, the ad may include or reference a telephone number, an address, a website, pricing information, and/or other information associated with a good and/or service. According to the particular implementation, the ads may be stored in one or more tables in a relational database described in terms of SQL statements or scripts. In certain implementations, the ads may be formatted, stored, or defined as various data structures. In short, requested ads may comprise one table or file or a plurality of tables or files stored on one computer or across a plurality of computers in any appropriate format. Indeed, some or all of requested ads may be local or remote without departing from the scope of this disclosure and store any type of appropriate data. In the case of remote ads, certain slots, whether embedded in the menus or in the video content itself, may be sold or allocated in advance and served by one or more ad providers 150. Put simply, ad provider 150 comprises any entity that employs, operates, owns, or controls an electronic device (e.g., computing device) that receives, transmits, processes, or stores ads for distributed service.

In one aspect of operation, the viewer of television 102 makes a selection based, at least in part, on information displayed on the television in the GUI 116. The television 102, or convertor 104, transmits the request to the client 108 using the convertor 104. In response to the request, the client 108 transmits a request 170a for content the server 110. The video content manager 130 identifies one or more content profiles 140 based, at least in part, on the content request and transmits content information 170b to the client 108. For example, the video content manager 130 may transmit a network address and information for accessing the request content. In connection with the content request, the video content manager 130 may identify one or more ad files 145 based, at least in part, on the request. The video content manager 130 may directly transmit ad included in the identified files 145 to the client 108 for embedding in the requested content. Using the content information, the client 108 retrieves or otherwise accesses the content 160a from the content provider 106a and transmits the content to the convertor 104. The convertor 104 converts the content to a form compatible to the television 102 and passes the converted content 160b to the television 102 for presenting to the user.

Turning to more specific examples of the processes implemented within various software to achieve the foregoing operations, FIG. 4 is a flowchart depicting an example technique 400 for processing viewer input to locate distributed video content. Specifically, process 400 begins at step 405, where video content manager 130 receives viewer input 170a. For example, this viewer input 170a can be one or more menu element selections in an effort to locate video content, search terms, and so forth. This input is typically entered through the television GUI 116 using a remote control or other input device. The input would then be communicated to client 108 for processing and transmission to server 110. In some cases, video content manager 130 determines at decisional step 410 if the client software is out-of-date (or otherwise not stable or current) using any suitable technique including invoking a web service or API, analyzing the input from the client, and so on. If the client software is out-of-date, then video content manager 130 may transmit or request transmission of appropriate patches, files, configurations, menu selections, images, and other updates to the client 108 at step 415. When appropriate, video content manager 130 then requests new input 170a from the viewer at step 420.

Once the input is received in the appropriate format or with the appropriate data, then video content manager 130 can parse the input at step 425. This parsing may include converting the input into a different format, identifying missing or useable data, decompressing the input, authenticating the input, or otherwise processing the input. Next, at step 430, the video content manager 130 maps the input to the content profile 140 repository. As described above, the input may be hierarchical such that it conforms to the hierarchical repository. Based, at least in part, on this mapped input, the video content manager 130 can then select content profiles 140—if any—at step 435. This selection can use queries, links, or other appropriate techniques. Appropriate information 170b from the selected content profiles 140 are then communicated to the viewer, through client 108 and television 102 at step 440. Examples of such appropriate information include filtered data based on viewer preferences, child locks, financial considerations, and so forth. In another example, video content manager 130 may only send some of the information from the selected content profile (such as not sending the age of the content registration) or send converted forms of the information (such as converting www.youtube.com to “YouTube”).

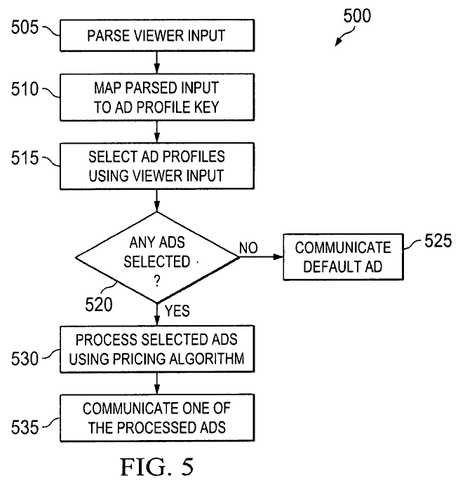

FIG. 5 is a flowchart depicting an example technique 500 for processing viewer input to locate targeted advertisements. Specifically, process 500 begins at step 505, where video content manager 130 parses the input. As above, this parsing may include converting the input into a different format, identifying missing or useable data, decompressing the input, authenticating the input, or otherwise processing the input. Next, at step 510, the video content manager 130 maps the input to the ad files 145. This mapping (or the earlier parsing) may include enhancing the input with information such as viewer location, age, gender, income level, family status, and any other suitable (whether known, determined, or presumed) marketing information. Based, at least in part, on this mapped input, the video content manager 130 can then select one or more ads 145—if any—at step 515. This selection can use queries, links, or other appropriate techniques. If no suitable ads were located, identified, or otherwise selected at decisional step 520, then video content manager 130 may transmit a default ad, such as an advertisement for the entity associated with server 110, one of the content providers 106, user help or guides, and so forth at step 525. But if suitable ads 145 are found, then video content manager 130 may subject the selected ads to various algorithms to increase revenue, reduce lag, filter less appropriate ads, verify the timeliness of ads, and so forth. Appropriate information from the processed ads 145 are then communicated to the viewer, through client 108 and television 102 at step 535. This communication may be farmed out to ad servers, such as ad provider 150, or other third parties as appropriate.

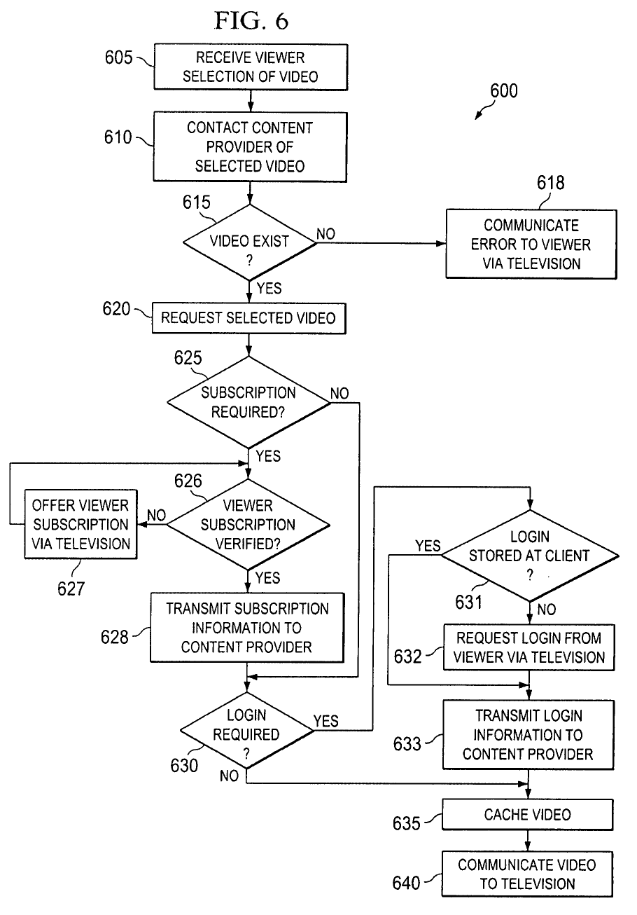

FIG. 6 is a flowchart depicting an example technique 600 for processing viewer input at the local client to present the selected video on the television 102. While described in terms of being executed by GUI 116, it will be understood that this description includes processing by software 118 at client 108 (such as an application, module, or agent) that is communicably coupled with GUI 116 displayed on the television 102.

Turning to the illustrated embodiment, technique 600 begins at step 605, where the viewer selects a particular network-based video for viewing on the television 102. This selection often occurs via the viewer pressing one or more buttons on a remote control that sends a signal to television 102 or, more specifically, set-top convertor 104. But this selection can be through any suitable communication device. Next, at step 610, GUI 116 contacts the content provider 106 of the selected video. If it is determined that the particular video no longer exists at decisional step 615, then the viewer is presented with an error or “apology” message at step 618.

If the video exists at this or another mirror site, then the selected video is requested for transmission. Of course, this request could occur concurrently with the contact at step 610 as appropriate. Regardless, this request could include an indication of the client's logical location, a request for an ftp, streaming, or other protocol session, an indication of the desired format, and so forth. Some content providers 106 may require a subscription to view some or all of their content. For example, a website may offer a number of free videos to visitors accessing the site via a web browser at client 108. But this website may also offer a premiere service with access to other videos for a fee, payment plan, or other subscription. If a subscription is required by the content provider for the selected video, then GUI 116 may automatically verify the subscription on behalf of the viewer at step 626, whether by sending information stored in a cookie at client 108, collecting credit card information from the viewer, and so on. If the viewer does not have a current or active subscription, the content provider 106 can offer the viewer a subscription over the television 102 through GUI 116 at step 627. While the illustrated flowchart indicates that the process returns to verify the (new) subscription, any other appropriate steps may be taken (particularly if the viewer does not take the offered subscription) including offering a different subscription, presenting an error message, providing an edited form of the video (lower resolution, reduced length), providing a different video, and soon. That aside, once the appropriate subscription information is collected or otherwise collected at decisional step 626, then GUI 116 transmits this information to the content provider 106 (or a payment processor as appropriate) at step 628.

Content provider 106 can, alternatively or in combination to the subscription processing, require that the viewer log-in to the site or to view the particular video, as shown at decisional step 630. For example, the video may contain adult material, for which the content provider 106 would require an adult verification or log-in. If the log-in is required, then GUI 116 may automatically log-in the viewer in a manner transparent to or hidden from the viewer as shown at steps 631 and 633. For example, the GUI 116 may perform authentication processing, collect information from a cookie, or perform other log-in processing without viewer input. Otherwise, at step 632, GUI 116 receives some viewer input, such as a log-in, password, or other information for transmission to the content provider. After the various (and optional) authentication checks are performed, the client 108 begins receiving the video in a digital, network-based, format 160a. This video can then be cached for any appropriate time period or buffer size at step 635. Once the video is ready, it is then transmitted to the television 102 at step 640 in a different format 160b compatible with the television. In many circumstances, the video is transmitted to the television through convertor 104, which can be coupled with the television (perhaps through an HDMI port or the like). In other circumstances, the client software 118 may perform some or all of the conversion using particular codecs or service profiles.

While the present disclosure uses flowcharts and accompanying descriptions to illustrate the exemplary processes, system 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. For example, the parsing of viewer input, shown at steps 425 and 505 may represent the same process executed by video content manager 130. Indeed, example techniques 400 and 500 may occur relatively concurrently such that the appropriate ads are embedded with the video content information without noticeable loss of performance. In another example, the subscription processing and the login-information processing may occur concurrently. In yet another example, video content manager 130 may automatically serve new ads after a certain time period without receiving new input from the viewer. Moreover, environment 100 may use methods with additional steps, fewer steps, and/or different steps, so long as the method remains appropriate. For example, if the video does not exist at the particular content provider 106 (at step 615), then GUI 116 may be dynamically redirected to a backup or different content provider. In another example, if the video does not exist at the particular content provider 106 (at step 615), then GUI 116 may be provided with a different video offering from the same site. This redirection may be transmitted to server 110 for automatic updating of the content profiles 140, thereby reducing future viewers from being redirected and suffering performance delay.

Although this disclosure has been described in terms of certain embodiments and generally associated methods, alterations and permutations of these embodiments and methods will be apparent to those skilled in the art. Accordingly, the above description of example embodiments does not define or constrain the disclosure. Other changes, substitutions, and alterations are also possible without departing from the spirit and scope of this disclosure, and such changes, substitutions, and alterations may be included within the scope of the claims included herewith.

What is claimed is:

1. Software for providing network-based video over a television comprising computer readable instructions embodied on tangible media and operable to:
provide a graphical user interface (GUI) to the television for presentation to a viewer;
in response to input through the GUI, identify a plurality of remote video content providers; and
provide a video from one of the remote video content providers over a computer network to the television.

2. The software of claim 1, wherein providing the video from one of the remote video content providers over the computer network to the television comprises communicating the video to a converter, communicable coupled with the television, for conversion to a format compatible with the television.

3. The software of claim 2, the video obtained from the particular video content provider following a Motion Picture Experts Group (MPEG) standard and the converted video following a National Television System Committee (NTSC) standard.

4. The software of claim 1, wherein providing the video from one of the remote video content providers over the computer network to the television comprises caching at least a portion of the video in memory prior to communication to the television.

5. The software of claim 1 further operable to embed at least one advertisement in the GUI presented through the television based on the input.

6. The software of claim 5 further operable to:
filter the plurality of remote video content providers into a targeted plurality of remote video content providers based on additional viewer input through the GUI; and
replace the embedded advertisement with a new advertisement based on the additional view input.

7. The software of claim 6, the video supplied from one of the targeted plurality of remote video content providers.

8. The software of claim 6, the targeted plurality of remote video content providers filtered based on video subject matter.

9. The software of claim 1 further operable to embed one or more advertisements in the video prior to display on the television.

10. The software of claim 1, wherein identifying the plurality of remote video content providers comprises communicating with a central repository storing identifiers associated with at least a subset of the video content providers.

11. The software of claim 10 further operable to:
receive a logical location for the video based, at least in part, on the respective identifier for the particular video content provider; and
request the video from the particular video content provider.

12. The software of claim 10 further operable to authenticate the viewer with the central repository.

13. The software of claim 1 further operable to provide a second video from a second one of the remote video content providers over a computer network to the television, the second video content provider disparate from the first video content provider.

14. The software of claim 13, the second video comprising a television show stored on a server accessible via the computer network.

15. The software of claim 1 capable of communicating with the television over a local wireless network.

16. The software of claim 1, the television comprising an ATSC tuner and a plurality of digital inputs.

17. The software of claim 1, the input communicated to the GUI from a remote control through an infrared port on the television.

18. The software of claim 1, the computer network comprising an Internet Protocol (IP) based network.

19. The software of claim 1, the GUI comprising a hierarchical GUI.

20. Software for providing network-based video over televisions comprising computer readable instructions embodied on tangible media and operable to:
query a central repository, storing information associated with a plurality of remote video content providers, in response to a request from a remote client, the request originating from a first graphical user interface (GUI) displayed on a first television;
provide information associated with a subset of the plurality of remote video content providers, selected based on the query, to the remote client; and
query the central repository in response to request from a second remote client, the request originating from a second graphical user interface (GUI) displayed on a second television.

21. The software of claim 20, the first GUI comprising a hierarchical GUI and the software further operable to communicate hierarchy updates to the GUI.

22. The software of claim 20, the provided information comprising a Uniform Resource Locator (URL) to a video for presentation on the first television.

23. The software of claim 20 further operable to present a registration GUI to a new remote video content provider to be added to the plurality of remote video content providers.

24. The software of claim 23, the registration GUI comprising a plurality of fields capable of accepting video information and associated URLs for storage in the central repository.

25. The software of claim 24, the video information input via a plurality of hierarchical pull-down menus associated with video subject matter.

26. The software of claim 20 further operable to automatically delete information from the central repository based on age.

27. The software of claim 26 further operable to:
notify the video content provider of the information to be deleted; and
reset the age of the information in response to a request from the video content provider to postpone the automatic deletion.
